(19) United States
(12) Patent Application Publication
(10) Pub. No.: US 2001/0007566 A1
(43) Pub. Date: Jul. 12, 2001

(54) Method of managing call collision in a D channel

(76) Inventors: Karine Villatte, La Garenne Colombes (FR); Cao Thanh Phan, Rueil Malmaison (FR)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/725,860

(22) Filed: Nov. 30, 2000

(30) Foreign Application Priority Data
Jan. 6, 2000 (FR) 00 00 120

(51) Int. Cl. H04L 12/413; H04J 3/22

(52) U.S. Cl. 370/445; 370/465

(57) ABSTRACT

In a method of managing call collisions, in the event of a bit rate collision or a logical channel collision occurring at the time of a request to set up a call between a first terminal and a second terminal, one terminal is designated the master terminal and the other terminal is designated the slave terminal. Depending on the source of the call request packets, the two calls are automatically transmitted via the signaling channel or a data channel.

### BACKGROUND OF THE INVENTION

1. Field of the Invention

The invention relates to a method of managing call collisions. The invention relates more particularly to a method of managing call collision on bi-directional inter-exchange trunks linking private exchange terminals, for example private automatic branch exchanges (PABX).

The general field of the invention is that of a homogeneous network of PABX terminals interconnected by inter-exchange trunks and connected to an integrated services digital network (ISDN).

2. Description of the Prior Art

As a general rule, an inter-exchange trunk between two terminals defines a set of transmission lines leased or purchased by users from a public service and providing access to the terminals. In physical terms, there is a number of access channels. For example, basic rate (T0) inter-exchange trunks support two data transmission channels, referred to as B channels, which have a bit rate of 64 kbit/s, and one signaling channel, referred to as a D channel, which has a bit rate of 16 kbit/s. Primary rate (T2) inter-exchange trunks support 30 B channels and one D channel, all of which channels have a bit rate of 64 kbit/s.

All the above inter-exchange trunks are non-dedicated in the sense that each is able to provide all the services offered by the network within a limit imposed by its bit rate. As a general rule, the B channel can be used to convey any type of information, in either digital or analog form, and consisting either of packets of data or of telephone signals. The D channel is able to convey the signaling associated with various services in packet-switched mode. The D channel is essentially used for call set-up on the various channels. It conveys information sent in the form of call request packets by a terminal to request that a call be set up to another terminal, for example. The information can be a logical channel number of the inter-exchange trunk required to transmit the subsequent data packets, a B channel number for transmitting the subsequent data packets, the address of the destination, the type of data packet sent, and so on.

A level 2 protocol, also referred to as a link access protocol on the D channel (LAPD), is used for secure frame exchange between terminals, terminal adapters, digital subscriber line terminations, switches, etc. which provide functions which conform to the high-level data link control (HDLC) principle. An LAPD address field consists of two bytes: the first byte contains principally a service access point identifier (SAPI) and the second byte contains a terminal end-point identifier (TEI). These two identifiers enable a plurality of access protocol links to be multiplexed into the same D channel. The SAPI enables the frame to be routed to an interested entity, for example a signaling processor, a data packet switch or a management entity. The TEI is used to address a particular terminal on a passive bus.

The user leases the signaling and data channels from a public service. The signaling channel, i.e. the D channel, is set up permanently between the two terminals at its ends. The user therefore pays continuously for the use of the channel. In contrast, the cost of the data channels, i.e. the B channels, varies: it comprises a fixed subscription amount and an amount which depends on the quantity of data exchanged on each of the B channels. Economic considerations lead the user of a network of the kind in which the method in accordance with the invention is used to limit the number of B channels leased and their use of those channels. The user can also use the D channels to transmit certain data of a non-urgent character, i.e. not telephone data, but data packets circulating between two computers, for example. Because the cost of a D channel does not depend on the volume of information exchanged on it, the user uses the D channel to the maximum of its capabilities.

However, the user is limited by certain characteristics of the D channel, which is defined essentially by its bit rate and by the number of logical channels it has available.

By definition, the bit rate of a D channel corresponds to the number of bits that the channel can transmit per unit time. The number of logical channels of a D channel corresponds to the maximum number of multiplexed calls that a channel can set up simultaneously. A D channel usually provides a bit rate of 16 kbit/s and eight logical channels.

A call via a bi-directional inter-exchange trunk is effected in two stages: first, a terminal sends a call request packet to another terminal to set up the call and to specify certain characteristics of the call. If the call set-up request is accepted, data packets can then be sent.

A user of one of the terminals of the network concerned can encounter two types of collision problem on attempting to transmit data via a D channel. Those two types of collision will now be explained.

A D channel has an inherent bit rate DO which corresponds to the maximum bit rate that can be used on the channel. At any given time a D channel is characterized by an available bit rate DN which corresponds to the difference between the inherent bit rate D0 and the sum of the bit rates in use at that time for various data transmissions. When a terminal requests call set-up to another terminal via a D channel, it sends data in the form of a call request packet on the D channel. The call request packet includes a header indicating the nature of the data packet, the logical channel number on which the sending terminal wishes to send subsequent data packets, the address of the destination terminal and the bit rate D1 required for the call, in order to transfer the data packets.

If the bit rate D1 required is greater than the bit rate DN available the call cannot be set up via the D channel. The call request packet and the data packets will then be transmitted via one of the B channels after the user has sent a new call request packet to set up the corresponding call. The request for call set-up via the D channel has been rejected.

If the bit rate D1 required is less than the bit rate DN available and no call set-up request is sent by the destination terminal, then the call is possible. The data packets can be transmitted via the D channel.

If the bit rate D1 required is less than the bit rate DN available but a call setup request in the form of a call request packet is sent by the destination terminal at a nearby time, the call request packet from the latter terminal including a header stipulating that it requires a bit rate D2, and if the sum of the two bit rates D1+D2 is greater than the bit rate DN available, then there is a bit rate collision situation. The expression “nearby time” means that the call set-up request sent by the second terminal is sent after the first terminal has itself sent its call set-up request, but before the call request packet from the first terminal has reached the second terminal. In the event of a bit rate collision, the two destination terminals of the call request packets send back to the terminal sending the call set-up request data referred to as a call release packet which informs each sending terminal of the bit rate collision. Consequently, no call is set up. Both call requests must be repeated subsequently.

If there is only one remaining logical channel available on the D channel and two terminals connected by an inter-exchange trunk containing that D channel send call set-up requests at nearby times by means of call request packets similar to those previously described, the call set-up requests are rejected. There is then a logical channel collision situation.

In the prior art, logical channel collisions and bit rate collisions lead to release of both call set-up requests. Each terminal that has received a call release packet must subsequently attempt call set-up again. This is a constraint and usually leads to time being wasted in exchanging data between terminals.

The method according to the invention overcomes the shortcomings and disadvantages just described. To this end, the method according to the invention uses means which avoid finally releasing any call set-up requests effected, even in bit rate or logical channel collision situations. To this end, one of the two terminals is designated as the master terminal and the other terminal is then designated as the slave terminal.

In the case of a bit rate collision, the master terminal which has received a call release packet instantaneously retransmits its call set-up request on the D channel. The slave terminal which has received a call release packet observes a time-delay before automatically sending its call set-up request again, and if the available bit rate is still too low for the required transfer of data, the data packets are then transmitted on another B channel.

### SUMMARY OF THE INVENTION

Thus the invention provides a method of controlling collisions, on a bi-directional inter-exchange trunk providing communication linking first and second private automatic branch exchange terminals, between a first call request packet requesting call set-up sent by the first terminal to the second terminal and a second call request packet requesting call set-up sent by the second terminal to the first terminal, the two call request packets being sent at nearby times by each of the two terminals on a signaling channel of the inter-exchange trunk, the signaling channel being defined in particular by a bit rate and by a number of logical channels which are specific to it, which method includes the step of allocating a master mode to one of the two terminals, which is then referred to as the master terminal, and a slave mode to the other terminal, which is then referred to as the slave terminal, in order to determine call set-up process steps for transmitting data packets associated with the first and second call request packets.

In a preferred embodiment of the invention, in the case of a bit rate collision, the steps of setting up the call consist of:

detecting excess bit rate call request packets in which the required bit rate is too high by comparing the bit rate required by each call request packet to a bit rate available at the terminal receiving the call request,

sending a collision message to each terminal that has sent an excess bit rate call request packet,

if necessary, propagating directly a call request packet that has not been detected as being an excess bit rate call request packet, and

sending the excess bit rate call request packet or packets again and either instantaneously in the case of a call request packet sent by the master terminal or after a time-delay in the case of a call request packet sent by slave terminal.

The call request packets that are sent after a time-delay are sent on a channel other than the signaling channel. They can be followed by data packets which are switched to the same channel as the call request packets. The duration of the time-delay can depend on the size of the data packets to be sent after the call request packet of the call set-up request sent by the master terminal.

In a different embodiment of the method according to the invention the time-delay has a fixed duration of two seconds.

Also, in the event of a logical channel collision, the call set-up process steps consist of:

propagating a call request packet from the master terminal directly, and

sending a call request packet from the slave terminal again on a channel other than the signaling channel.

The master mode or the slave mode can be allocated to each terminal according to a number specific to the terminal. In a homogeneous network, each terminal constituting a node of the network is numbered. Its number can correspond to the chronological order in which that terminal was commissioned in the network, for example. In a different embodiment of the method according to the invention the master mode or the slave mode is allocated to each terminal according to the number of adjacent terminals. Two terminals are referred to as adjacent if there is an inter-exchange trunk between the two terminals which connects them directly. In the homogenous networks to which the method according to the invention applies, each terminal contains data indicating the number of adjacent terminals.

The aspects and advantages of the present invention will be understood better after reading the remainder of the description, which refers to the figures, which are provided by way of non-limiting and illustrative example only.

### BRIEF DESCRIPTION OF THE DRAWINGS

FIG. 1 shows the use of the method according to the invention in the case of a bit rate collision detected by two terminals connected by an inter-exchange trunk.

FIG. 2 shows the use of the method according to the invention in the case of a bit rate collision detected only by a master terminal.

FIG. 3 shows the use of the method according to the invention in the case of a bit rate collision detected only by a slave terminal.

FIG. 4 shows the use of the method according to the invention in the case of a logical channel collision.

### DETAILED DESCRIPTION OF THE PREFERRED EMBODIMENTS

In all of the figures, a first terminal T1 and a second terminal T2 are connected by an inter-exchange trunk 1 which includes a signaling D channel and a plurality of data transmission B channels. Terminal T1 is designated as the master terminal and terminal T2 is designated as the slave terminal. As previously explained, the master mode and the slave mode can be allocated in particular according to a number specific to the terminal and corresponding, for example, to the order in which the terminal concerned was commissioned in the homogeneous network. The master/slave designation can equally well be determined by the number of terminals adjacent each of the terminals concerned. In this instance, the master terminal can be designated as the terminal which has the greater number of adjacent terminals. Of course, any other method can be considered for designating one of two terminals connected by an inter-exchange trunk as the master terminal and the other terminal as the slave terminal.

In all the figures a vertical line 2 connected to the master terminal T1 symbolizes a time axis for identifying the time of occurrence of events involving the terminal T1. In the same way, a vertical line 3 connected to the slave terminal T2 symbolizes a time axis for identifying the time of occurrence of events involving terminal T2.

The events just referred to include:

the first sending of a call request packet on the D channel, the expression “call request packet” always corresponding to an attempt to set up a call to transmit data packets afterwards,

sending or receiving a call release packet signifying that the call request packet previously sent has not led to call set-up,

propagating a call request signifying that the call has been set up and that data packets can be transmitted, and

resending a call request packet.

The notation tₖ (X) along the time axes 2 and 3 signifies that at time k the apparent available bit rate for the terminal corresponding to one of the time axes has the value X.

The apparent available bit rate of an inter-exchange trunk is available in each terminal connected to the inter-exchange trunk and corresponds to the bit rate that the terminal in question considers to be available on the inter-exchange trunk at any time. It does not correspond to the bit rate that is actually available, because it does not allow for the value of the bit rates required by call request packets from the other terminal connected to the inter-exchange trunk which have not yet reached the terminal concerned.

The arrows between the two time axes symbolize steps of setting up the call between the two terminals. The dashed line arrows designate steps characteristic of the method according to the invention. In the drawings, the arrows with a black arrowhead correspond to operations occurring after the master terminal sends a call request packet. The arrows with solid line black arrowheads correspond to operations occurring after the slave terminal has sent a call request packet. The arrows with dashed line arrowheads correspond to operations relating to a call that had already been set up at the time of the various collisions considered.

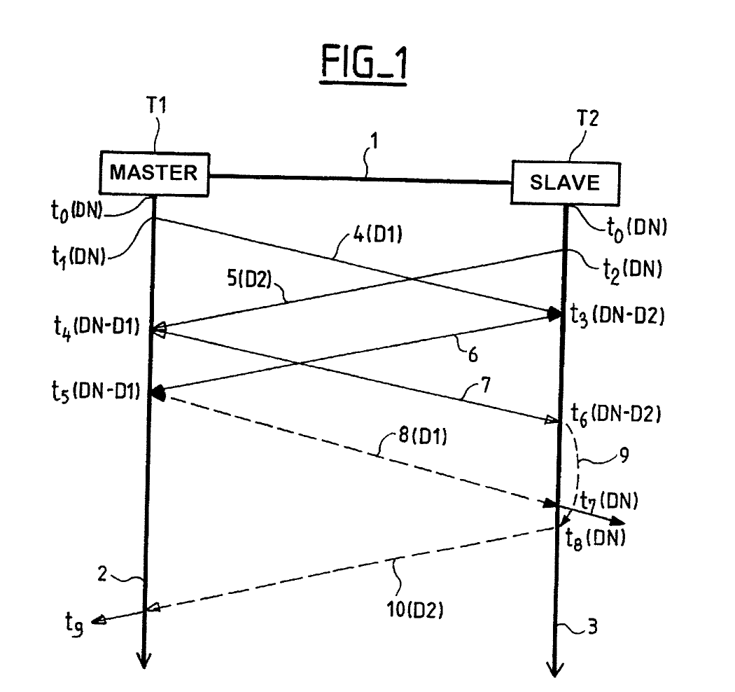

In FIG. 1, the master terminal T1 and the slave terminal T2 send at respective nearby times t1 and t2 a master call request packet 4 requiring a bit rate D1 and a slave call request packet 5 requiring a bit rate D2.

FIG. 1 shows the situation in which at a time t0 preceding times t1 and t2 the bit rate available on the D channel has a value DN greater than D1 and D2 but less than D1+D2.

This is therefore the typical bit rate collision situation. The master call request and the slave call request are sent at nearby times, meaning that each of the two call request packets is sent before either of the call request packets reaches its destination.

The master call request 4 reaches terminal T2 at time t3. At time t3 the apparent available bit rate on the D channel has a value equal to DN−D2, which is less than D1. The master call request 4 is therefore detected as an excess bit rate call request.

A first collision message is then transmitted from terminal T2 to terminal T1 in the form of a first call release packet 6 for the master call request 4 which informs terminal T1 that the call set-up request has not been effected. In the same way, the slave call request 5 reaches terminal T1 at time t4. At time t4 terminal T1 indicates that the apparent bit rate available has a value equal to DN−D1, which is less than the bit rate D2 required by the slave call request. A second call release packet 7 is therefore transmitted from terminal T1 to terminal T2. It informs terminal T2 that the slave call request 5 has not led to call set-up.

The first call release packet 6 reaches terminal T1 at time t5. At time t5 the apparent bit rate available for terminal T1 is still equal to DN−D1. According to the method in accordance with the invention, the master call request is immediately retransmitted in the form of a second master call request 8 identical to the first master call request 4.

The call release packet 7 reaches terminal T2 at time t6. At time t6 the apparent bit rate available for terminal T2 is still equal to DN−D2. According to the method in accordance with the invention, the slave call request 4 is not retransmitted immediately. A time-delay 9 is initiated. The time-delay 9 enables the second master call request 8 to reach terminal T2 at time t7, at which the available apparent bit rate is equal to DN. The call set-up request for the master call request 7 is then processed, the required bit rate D1 being less than the apparent bit rate DN available. Data packets following on from the call request packet can then be transmitted over the D channel. Thus the master call request is propagated directly.

The time-delay expires at time t8 at which the apparent bit rate available is equal to DN. A second slave call request 10 similar to the first slave call request 5 is then sent again. If necessary, the second slave call request 10 can effect a request to set up a call on a B channel. Depending on the apparent bit rate available for terminal T1, data packets of the slave call request can then be transmitted on the D channel or on a B channel.

As previously mentioned, the time-delay can have a predetermined fixed duration, for example of the order of two seconds, or depend on the size and the bit rate of the call request packets following on from the master call request that has propagated. In all cases, the time-delay must nevertheless be sufficient to enable the second master call request 8 to reach the slave terminal T2 before the end of the time-delay 9.

The second slave call request 10 reaches terminal T1 at time t9.

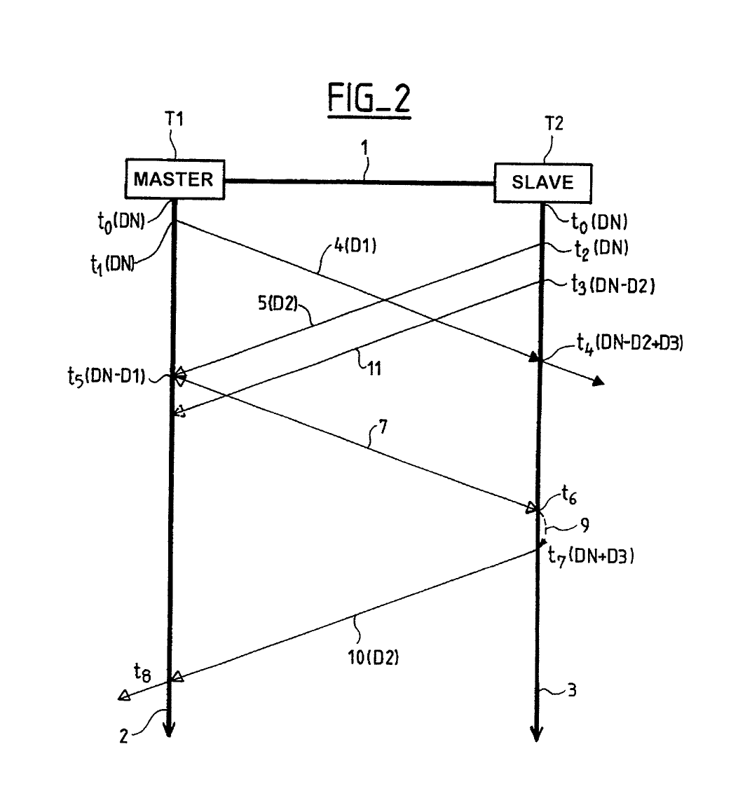

FIG. 2 also shows a bit rate collision and represents a special case of the situation shown in FIG. 1.

The master terminal T1 and the slave terminal T2 again send at respective nearby times t1 and t2 a master call request packet 4 requiring the bit rate D1 and a slave call request packet 5 requiring the bit rate D2. At time t0 preceding time t1 and t2 the bit rate available on the D channel has a value DN greater than D1 and D2 but less than D1+D2.

At time t3 the slave terminal T2 sends a message 11 signifying that a call previously set up has terminated. The call previously set up required a bit rate D3. The bit rate D3 is therefore released and can therefore be used for the calls attached to the call request packets 4 and 5.

The call request packet 4 reaches terminal T2 at time t4 after time t3 at which the bit rate D3 was released. At time t4 the apparent available bit rate on the D channel has a value equal to DN−D2+D3, if that value is greater than the bit rate required for the call request packet 4, namely D1, which is the case shown in FIG. 2, then the call following on from the call request packet 4 can be set up directly. The data packets following on from the call request packet 4 can pass over the inter-exchange trunk 1.

On the other hand, the slave call request 5 which reaches terminal T1 at time t5 generates a call release packet 7 which is transmitted from terminal T1 to terminal T2. At time t5, the apparent available bit rate given by terminal T1 is still equal to DN−D1. The call release packet 7 informs terminal t2 that the slave call request 5 has not led to call set-up.

The second call release packet reaches terminal T2 at time t6. At time t6 the apparent bit rate available for terminal T2 has the value DN−D2+D3, assuming that the call following on from the master call request 4 has not terminated. According to the method of the invention, the slave call request 5 is not retransmitted immediately. The time-delay 9 is initiated. It expires at time t7, at which the available apparent bit rate is equal to DN+D3. The second slave call request 10, which is similar to the first slave call request 5, is then sent again. If necessary, the second slave call request 10 can request setting up of a call on a B channel.

The situation represented in FIG. 2 illustrates the fact that, if a certain bit rate is released between the time at which a master call request packet is sent by terminal T1 and the time at which that master call request packet reaches terminal T2, the call can be set up directly to transmit the data packets associated with the master call request. No call release packet is sent from terminal T2 to terminal T1. On the other hand, in the method of the invention, a call release packet indicating that a slave call request packet has not led directly to call set-up automatically initiates the time-delay 9.

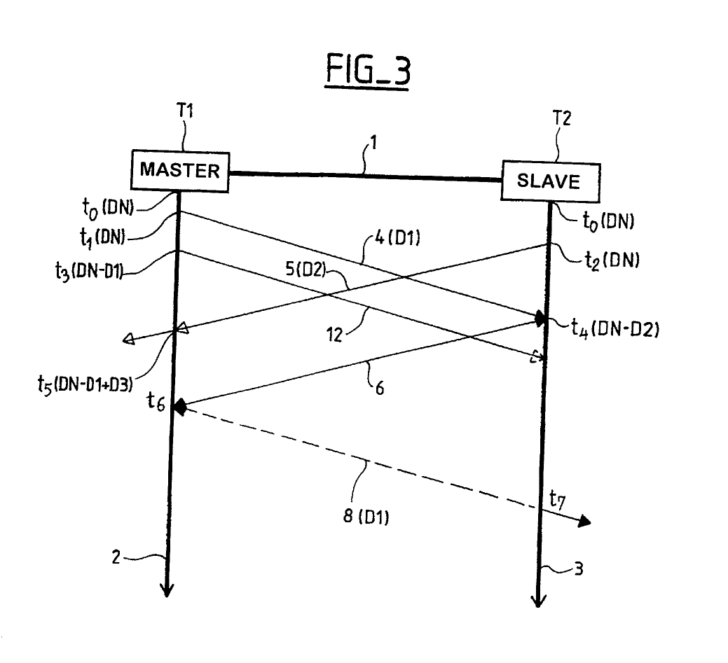

FIG. 3 shows a situation similar to that shown in FIG. 2 except that a bit rate collision is processed in the situation where transmission of data from terminal T1 to terminal T2 initiated before any collision event terminates at a particular time. The situation is still one in which the master terminal T1 and the slave terminal T2 send at respective nearby times t1 and t2 the master call request packet 4 requiring the bit rate D1 and the slave call request packet 5 requiring the bit rate D2.

At time t0 preceding times t1 and t2 the bit rate available on the D channel has a value DN greater than D1 and D2 but less than D1+D2. The situation is therefore still that of a bit rate collision.

At time t3 a signal 12 is sent from the master terminal T1 to the slave terminal T2 to report that a call previously set up from the master terminal T1 to the slave terminal T2 has terminated. That call required a bit rate D3. Consequently, the slave call request packet 5 that reaches the master terminal T1 at time t5 finds an apparent bit rate of value DN−D1+D3 available (when t5 is after t3, obviously). In this case, and if the bit rate D2 is less than DN−D1+D3, data packets can be transmitted directly from terminal T2 to terminal T1 via the D channel. No call release packet is sent after sending the call request packet 5.

On the other hand, at time t4 corresponding to the time at which the call request packet 4 reaches the slave terminal T2, the apparent bit rate available is DN−D2. Consequently, a call release packet 6 is sent from the slave terminal to the master terminal T1. It informs terminal T1 that the master call request 4 has not led to call set-up. The call release packet reaches terminal T1 at time t6. According to the method in accordance with the invention, it is retransmitted instantaneously in the form of a second master call request packet 8 similar to the first master call request packet 4. The second master call request packet 8 reaches terminal T2 at time t7. At time t7, a decision is taken as to whether data packets following on from the call request packet 8 will be transmitted on the D channel or on a B channel, depending on the available bit rate.

Note, in the situation described with reference to FIG. 3, that the method according to the invention enables automatic transmission of two call requests without any time-delay.

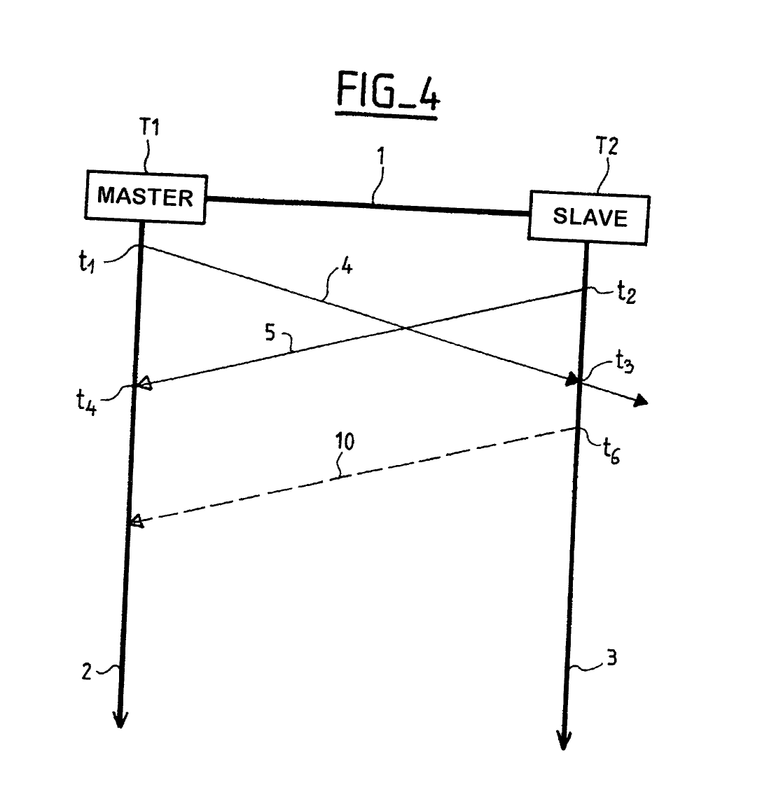

FIG. 4 shows the use of the method according to the invention in the case of a logical channel collision. In this example, the bit rate of the inter-exchange trunk 1 is assumed to be sufficient for simultaneously transmitting the calls that must be set up following the first call request packet 4 or the second call request packet 5. On the other hand, in the situation shown, it is assumed that there is only one logical channel of the inter-exchange trunk D available for exchanging data between terminal T1 and terminal T2. The two call request packets 4 and 5 are again sent at nearby times t1 and t2. According to the method in accordance with the invention, the master call request packet 4 reaches the slave terminal T2 at time t3. It is then propagated immediately and the data packets which follow on from it can be transmitted on the D channel. On the other hand, the slave call request packet reaches the master terminal Ti at time t4. The call set-up request is then refused. A second slave call request packet 10 similar to the first slave call request packet 5 is then sent again from terminal T2 to terminal T1 at time t6. The second slave call request packet 10 is different from the first slave call request packet 5 in that it requests the setting up of a call and a transfer of data packets on a B channel.

As a general rule, in the case of a logical channel collision, when two call request packets are sent at nearby times by terminal T1 and terminal T2, the call request packet from the master terminal T1 is processed to set up a call immediately so that data packets which follow on from the call request packet 4 can be transferred. The slave terminal T2, having received the master call request packet 4 which requests the setting up of a call on a logical channel that it had itself requested in the slave call request packet 5, therefore knows that it has not been possible to set up the call following on from the slave call request packet 5.

The slave terminal T2 therefore retransmits a new call request packet 10 requesting setting up of a call via a B channel virtually instantaneously.

There is claimed:

1. A method of controlling collisions, on a bi-directional inter-exchange trunk providing communication linking first and second private automatic branch exchange terminals, between a first call request packet requesting call set-up sent by said first terminal to said second terminal and a second call request packet requesting call set-up sent by said second terminal to said first terminal, said two call request packets being sent at nearby times by each of said two terminals on a signaling channel of said inter-exchange trunk, said signaling channel being defined in particular by a bit rate and by a number of logical channels which are specific to it, which method includes the step of allocating a master mode to one of said two terminals, which is then referred to as the master terminal, and a slave mode to the other terminal, which is then referred to as the slave terminal, in order to determine call set-up process steps for transmitting data packets associated with said first and second call request packets.

2. The method claimed in claim 1 wherein, in the event of a bit rate collision, the call set-up process steps consist of:
detecting excess bit rate call request packets in which the required bit rate is too high by comparing the bit rate required by each call request packet to a bit rate available at the terminal receiving the call request,
sending a collision message to each terminal that has sent an excess bit rate call request packet,
if necessary, propagating directly a call request packet that has not been detected as being an excess bit rate call request packet, and
sending said excess bit rate call request packet or packets again and either instantaneously in the case of a call request packet sent by said master terminal or after a time-delay in the case of a call request packet sent by slave terminal.

3. The method claimed in claim 2, including the further step of switching said call request packets sent after a time-delay and data packets associated with said call request packets sent after a time-delay to a channel other than said signaling channel.

4. The method claimed in claim 2 wherein said time-delay has a duration which depends on the size of the data packets to be sent after said call request packet of said call set-up request sent by said master terminal.

5. The method claimed in claim 2 wherein said time-delay has a duration of two seconds.

6. The method claimed in claim 1 wherein, in the event of a logical channel collision, the call set-up process steps consist of:
propagating a call request packet from said master terminal directly, and
sending a call request packet from said slave terminal again on a channel other than said signaling channel.

7. The method claimed in claim 1 wherein said master mode or said slave mode is allocated to each terminal according to a number specific to said terminal.

8. The method claimed in claim 1 wherein said master mode or said slave mode is allocated to each terminal according to the number of adjacent terminals.
